(19) United States
(12) Patent Application Publication
(10) Pub. No.: US 2012/0168099 A1
(43) Pub. Date: Jul. 5, 2012

(54) LOCK MECHANISM FOR A COVERING FOR ARCHITECTURAL OPENINGS

(76) Inventors: Richard Anderson, Whitesville, KY (US); Steven R. Haarer, Whitesville, KY (US)

(21) Appl. No.: 13/339,912

(22) Filed: Dec. 29, 2011

Related U.S. Application Data
(60) Provisional application No. 61/429,532, filed on Jan. 4, 2011.

(51) Int. Cl. E06B 9/68

(52) U.S. Cl. 160/368.1

(57) ABSTRACT

A locking mechanism for a covering for architectural openings includes at least one dog which cooperates with a stop surface to stop the high speed lowering of a rail that supports the covering while permitting the rail to be lowered at a slower speed and to be raised regardless of the speed.

This application claims priority from U.S. Provisional Application Ser. No. 61/429,532 filed Jan. 4, 2011, which is hereby incorporated herein by reference.

### BACKGROUND

This application relates to a lock mechanism for use in coverings for architectural openings. Such coverings may include Venetian blinds, Roman shades, roller blinds, garage doors, and various other types of coverings. In this specification, the term “blind” or “shade” refers to any of the above types of coverings.

In engineering, a dog is a mechanical device that prevents movement or imparts movement by offering physical obstruction or engagement of some kind. It may hold another object in place by blocking it, clamping it, or otherwise obstructing its movement.

### SUMMARY

The present invention relates to a dog mechanism which is used to prevent the rail supporting a covering from falling too quickly. It relies on centrifugal force to move the dogs to the “lock” position to stop the falling rail and then uses gravity to unlock the dog. In one embodiment, the locking dog mechanism includes a “shock absorber” feature which prevents the sudden stop of the locking dog mechanism from jolting the lift cords and other attached components of the drive train (such as lift drums and lift rods), thereby increasing their life cycle.

### BRIEF DESCRIPTION OF THE DRAWINGS

FIG. 1 is a perspective view of a blind including a locking dog mechanism made in accordance with the present invention, with the components inside the stationary head rail also shown in a partially exploded view above the head rail;

FIG. 2 is an enlarged perspective view of the components inside the head rail of FIG. 1;

FIG. 3 is a perspective view of the locking dog mechanism of FIGS. 1 and 2;

FIG. 4 is an exploded, perspective view of the locking dog mechanism of FIG. 3;

FIG. 5 is a view along line 5-5 of FIG. 4;

FIG. 6 is a view along line 6-6 of FIG. 4;

FIG. 7 is a sectional view of the locking dog assembly of FIG. 3;

FIG. 8 is a view along line 8-8 of FIG. 3, with the housing cover removed for clarity, showing the locking dogs in a position wherein the topmost dog has been swung out due to centrifugal force and is about to abut the stop shoulder on the housing;

FIG. 9 is the same view as FIG. 8, but showing when the dog retainer has rotated far enough for the top dog to abut the stop shoulder on the housing;

FIG. 10 is the same view as FIG. 9, with the dog retainer in substantially the same position as in FIG. 9, but showing when the dogs have fallen back in toward the hub of the housing, under the influence of gravity, such that they will clear the stop shoulder on the housing to permit rotation;

FIG. 11 is the same view as FIG. 8, with the dog retainer in substantially the same position as in FIG. 8, but showing that the dogs have fallen back in toward the hub of the housing, under the influence of gravity, such that they will clear the stop shoulder on the housing to prevent a lock up condition;

FIG. 12 is a side view of a locking dog of FIG. 4;

FIG. 13 is a perspective view, similar to FIG. 2, but for a second embodiment of a locking dog mechanism;

FIG. 14 is a perspective view of the locking dog mechanism of FIG. 13;

FIG. 15 is an exploded, perspective view of the locking dog mechanism of FIG. 14;

FIG. 16 is a perspective view showing the main components of the shock absorber feature of the locking dog mechanism of FIG. 15, with the locking dogs omitted for clarity;

FIG. 17 is an opposite-end, perspective view of the components of FIG. 16;

FIG. 18 is a perspective view of the assembled components of FIG. 16; and

FIG. 19 is a perspective view, similar to that of FIG. 18, but rotated 180 degrees in the direction of the arrow.

### DESCRIPTION

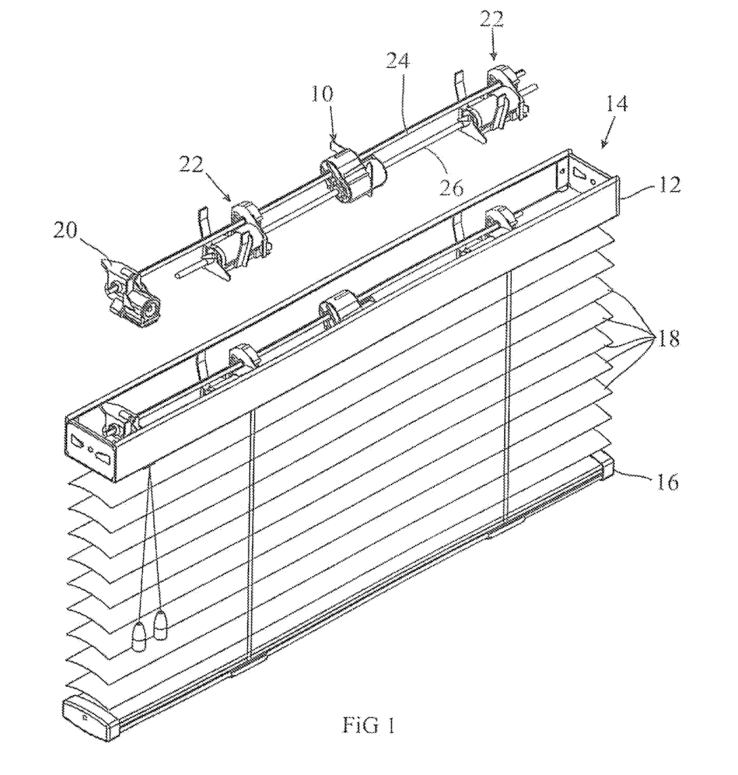

FIG. 1 shows a blind 14, including a stationary head rail 12, a movable bottom rail 16, suspended from the head rail 12 by lift cords and tilt cords, and a plurality of slats 18, which extend between and are supported by the head rail 12 and the bottom rail 16. In this embodiment, the slats 18 serve as a covering material to cover an architectural opening.

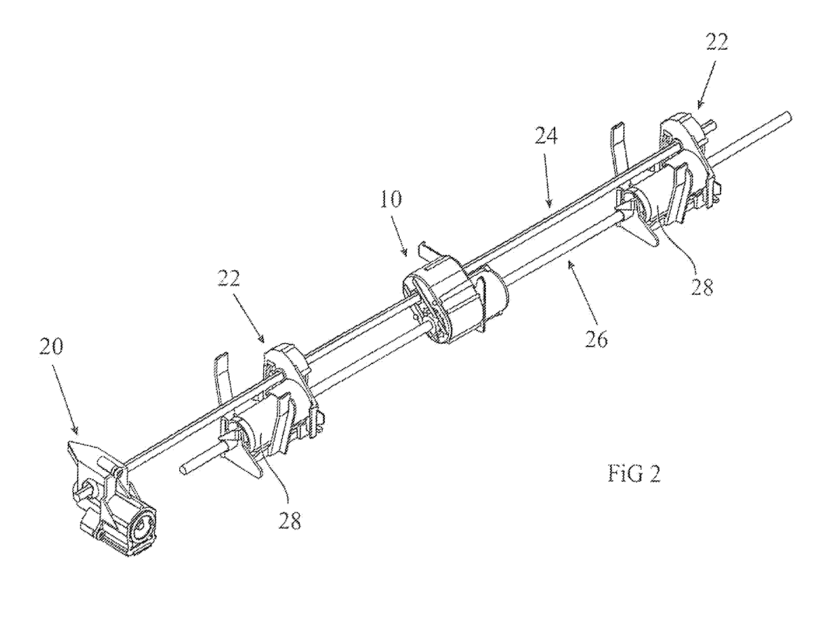

A first embodiment of a locking dog mechanism 10, made in accordance with the present invention, is mounted inside the head rail 12. Referring to FIGS. 1 and 2, the head rail 12 houses a tilt mechanism 20, two lift and tilt stations 22, and the locking dog mechanism 10. The tilt mechanism 20 is functionally connected to the lift and tilt stations 22, via a tilt rod 24. Rotating the tilt rod 24 tilts the slats 18 of the blind 14 open or closed. The lift and tilt stations 22 and the locking dog mechanism 10 are functionally interconnected, via a lift rod 26, for raising and lowering the slats 18 of the blind 14 and for holding the slats 18 in a desired position, as described in more detail below. With this particular embodiment of blind, which is known as a “top down” blind, lowering the movable bottom rail 16 lowers the slats 18 and extends the covering, and raising the bottom rail 16 and the slats 18 retracts the covering. If this were a “bottom up” blind, as is known in the art, then there would be a movable intermediate rail (not shown), with the slats extending between the intermediate rail and the bottom rail 16. In that case, lowering the movable intermediate rail (away from the head rail 12) would retract the covering and raising the movable intermediate rail (toward the head rail 12) would extend the covering.

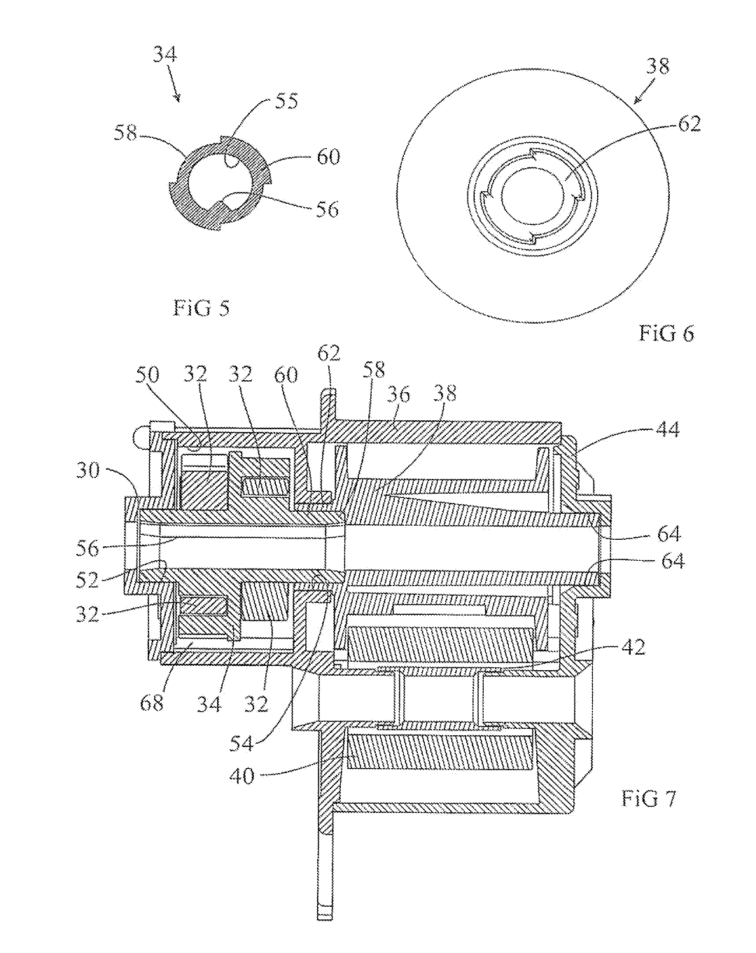

The lift and tilt stations 22 and the tilt mechanism 20 are described in detail in U.S. Pat. No. 6,536,503 “Anderson” (See FIG. 7, item 500A and item 760 of that reference, respectively), which is hereby incorporated herein by reference. As the horizontal lift rod 26 rotates, it rotates a take-up spool or lift drum 28 (See FIG. 2) on each of the lift and tilt stations 22 to either wind up or unwind the lift cords (not shown), which extend through holes in the slats 18 and are secured to the bottom rail 16, to raise or lower the bottom rail 16 of the blind 14. In this embodiment, the lift rod 26 and lift drum 28 rotate together about a single horizontal axis relative to the head rail 12 in which they are housed.

The locking dog mechanism 10 is designed so that it only locks the movable rail 16 against high speed movement in the lowering direction to prevent the movable rail 16 from falling downwardly. It allows the movable rail 16 to be moved downwardly at a slower, controlled speed, and it allows the movable rail 16 to be lifted upwardly at any speed without locking up the locking dog mechanism 10.

As described in more detail below, each of the dogs 32 is mounted on a locking dog retainer 34 (see FIG. 4), which, in this embodiment, rotates about the same axis of rotation as the lift rod 26 and lift drum 28. Each of the dogs 32 also rotates about a horizontal axis (parallel to the axis of rotation of the lift drums 28) relative to the locking dog retainer 34 as the locking dog retainer 34 rotates. The force of gravity tends to cause the dogs 32 to flare radially outwardly to an extended position, away from the axis of rotation of the locking dog retainer 34 as they approach the six-o-clock position and to retract radially inwardly to a retracted position, toward the axis of rotation of the locking dog retainer 34, as they approach the twelve-o-clock position. However, if the movable rail 16 is lowered too quickly, as in a free-fall situation, the centrifugal force acting on the dogs 32 overcomes the gravitational force that would otherwise have retracted the dogs 32 near the twelve-o-clock position, so the dogs 32 remain extended, and a surface on one of the dogs 32 contacts a stop surface on the housing to stop the movable rail 16.

Note that the tilt rod 24 passes through the locking dog mechanism 10 but is not functionally connected to it, as described in more detail later. It also should be noted that the locking dog mechanism 10, together with the other components housed in the top rail 12, alternatively could be housed in the movable bottom rail 16 or in an intermediate rail, if such an intermediate rail is present.

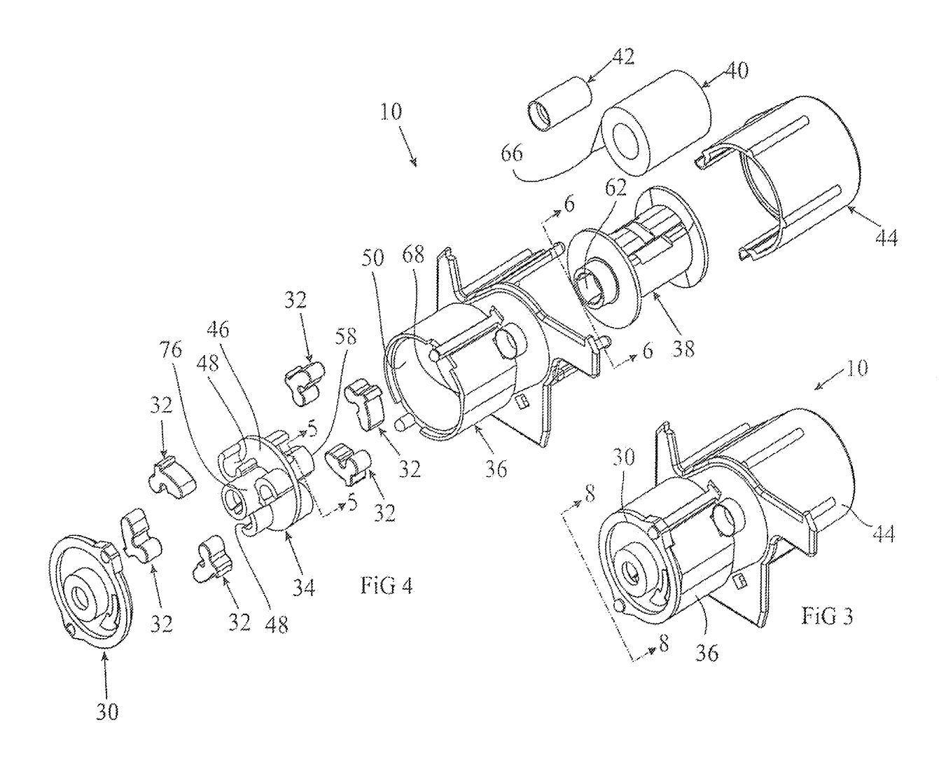

Referring now to FIGS. 3, 4, and 7, the locking dog mechanism 10 includes a housing cover 30, dogs 32, a dog retainer 34, a lock housing 36, an output spool 38, a motor spring 40, a storage spool 42, and a spring motor cover 44, so it includes both a locking mechanism and a spring motor power assist mechanism in a single unit. While, in this embodiment, the output spool 38 and the dog retainer 34 are separate pieces, they are functionally tied together and could alternatively be a single, unitary piece, if desired.

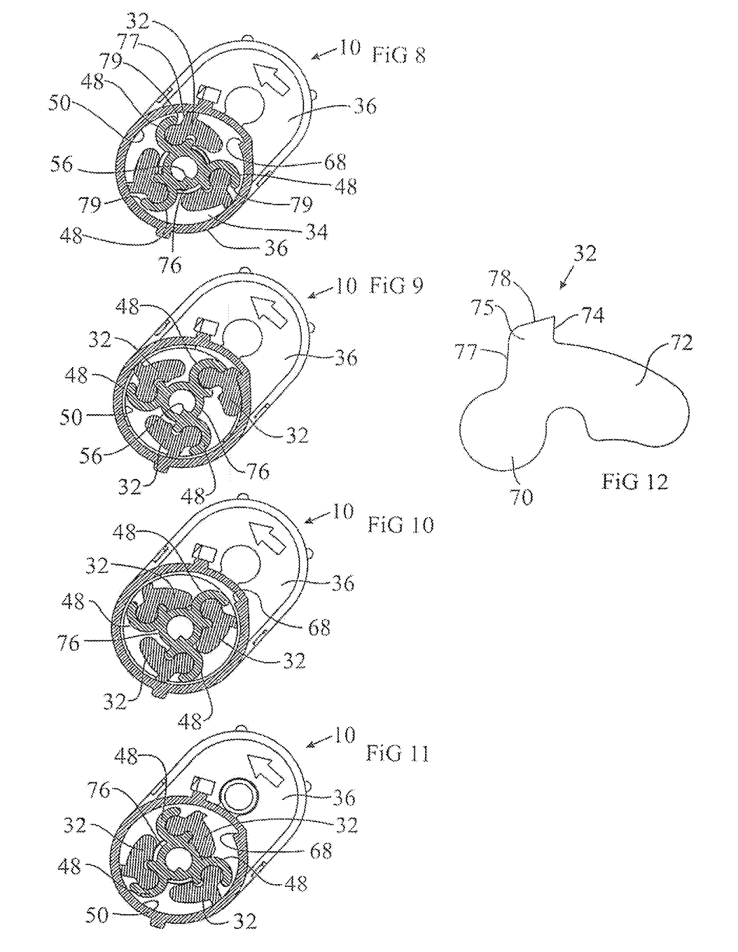

The dog retainer 34 has two, axially-opposed retainer faces on opposite sides of a central flange 46. Each retainer face defines three arcuate receptacles 48, each of which provides support that guides the respective received dog 32 for pivoting motion, as may be appreciated in FIGS. 8-11 and as described in more detail below. It should be pointed out that it is not necessary for each arcuate receptacle 48 to have a corresponding dog 32. Some of the receptacles 48 may be empty. Also, the number of arcuate receptacles 48 on each side of the flange 46 may vary from zero (wherein the arcuate receptacles 48 are on only one side of the flange 46) to as many as can be physically accommodated on the face of the flange 46. By having three arcuate receptacles 48 on each side of the flange 46, and by having these arcuate receptacles 48 staggered relative to each other on either side of the flange 46, it is possible to have an opportunity to stop the rotation of the lift rod 26 (and therefore of the blind 14 every 60 degrees of rotation, providing six equally-spaced-apart stopping opportunities per rotation).

Referring to FIG. 4, the flange 46 has an outside diameter which is slightly smaller than the inside diameter of the tubular cavity 50 of the lock housing 36 which is sized to house the dog retainer 34, as explained in more detail below. The depth of the dog retainer 34 is also substantially equal to the depth of the cavity 50 in the lock housing 36 such that, when the dog retainer 34 and its corresponding dogs 32 are assembled in the lock housing 36, they are encased in the cavity 50 and are unable to shift any appreciable distance in the axial direction within the assembled lock housing 36 and housing cover 30, as shown in FIG. 7. The lock housing 36 defines an axially-extending shoulder 68 (See also FIG. 8) along the inside surface of the cavity 50, extending parallel to the axis of rotation of the dog retainer 34. As explained later, this shoulder 68 provides a stop surface for the dogs 32 when they are swung out by centrifugal force caused by high speed rotation of the dog retainer 34.

Referring to FIG. 7, the housing cover 30 defines an annular recess 52 which provides rotational support for one end of the dog retainer 34. A similar annular internal surface 54 on the lock housing 36 rotationally supports one end of the output spool 38 which, in turn, provides rotational support for the other end 58 of the dog retainer 34.

The hollow bore 55 (See FIG. 5) of the dog retainer 34 defines an internal, non-circular cross-sectional profile. A radially extending V-shaped rib 56 matches and engages a similarly-shaped and sized trough in the cross-sectional profile of the lift rod 26 such that the lift rod 26 and the dog retainer 34 are positively engaged for rotation, but the dog retainer 34 may slide axially along the length of the lift rod 26. The locking dog mechanism 10 thus can be placed advantageously anywhere along the length of the lift rod 26.

As may be seen in FIG. 5, the shaft end 58 (See also FIG. 4) of the dog retainer 34 closest to the output spool 38 defines an external, non-circular cross-sectional profile 60. This external, non-circular cross-sectional profile 60 closely matches a similarly shaped internal, non-circular cross-sectional profile 62 (See FIG. 6) of the output spool 38, such that the dog retainer 34 and the output spool 38 are positively engaged for rotation. However, it should be pointed out that the output spool 38 does not have the non-circular cross-sectional profile with the rib 56 to engage the lift rod 26, which means that the output spool 38 is functionally connected to the lift rod 26 only through the dog retainer 34. Therefore, while the dog retainer 34 is directly subjected to the jarring force of the sudden stop of the dog 30 against the lock housing 36 and of the lift rod 26 against the dog retainer 34, other components are somewhat protected against that jarring force.

When the bottom rail 16 is being lowered, the lift cords cause the lift drums 28 to rotate, which causes the lift rod 26 to rotate, which causes the dog retainer 34 to rotate, which in turn causes the output spool 38 to rotate to wind the spring 40 onto the output spool 38. When the bottom rail 16 is being raised, the spring 40 unwinds from the output spool 38 and causes the output spool 38, lift rod 26 and lift drums 28 to rotate, to wind the lift cords onto the lift drums 28 and assist in raising the blind. This also causes the dog retainer 34 to rotate.

Alternatively, either the dog retainer 34, or the output spool 38, or both may be “keyed” for rotation with the lift rod 26 for the same end result.

As discussed earlier, the output spool 38 is rotationally supported at one end by the annular internal surface 54 in the lock housing 36. The other end of the output spool 38 is rotationally supported by an annular recess 64 in the motor cover 44 (See FIG. 7), which also functions as part of the housing. The concept of a motor spring 40, an output spool 38, and a storage spool 42 is disclosed in the aforementioned U.S. Pat. No. 6,536,503 “Anderson” (See FIG. 35, item 20E), which is hereby incorporated herein by reference. Briefly, the motor spring 40, when “at rest” is wound around the storage spool 42. A first end 66 of the spring 40 is secured to the output spool 38. As the operator pulls down on the bottom rail 16 of the blind 14 to extend the blind 14, the lift cords (not shown), which extend from the headrail 12, through holes in the slats 18, and which are secured to the bottom rail 16, unwind from the spools 28 of their corresponding lift and tilt stations 22, causing rotation of the spools 28 and of the lift rod 26. This causes rotation of the dog retainer 34 in the locking dog mechanism 10 (rotation is clockwise from the vantage point of FIGS. 4 and 8-11), and it also causes the spring 40 to unwind from the storage spool 42 and wind onto the output spool 38, increasing its potential energy.

As indicated earlier, and as explained in more detail later, if this lowering action is done in a relatively slow, controlled manner, the locking dog mechanism 10 does not stop the movement of the bottom rail 16. However, if the bottom rail is lowered too quickly (at a rate greater than a desired design rate, such as during free-fall of the bottom rail 16), the centrifugal force tending to pivot the locking dogs 32 outwardly into an extended position exceeds the gravitational force tending to retract the locking dogs 32, and causes the dogs 32 to be in the extended position shown in FIG. 8, so that one of the dogs 32 catches on the shoulder or stop surface 68 of the lock housing 36, as shown in FIG. 9, to releasably stop the movement of the bottom rail 16 and stop the extension of the covering 18.

Referring to FIG. 12, each dog 32 includes an arcuate, substantially circular, pivot portion 70, which is supported for pivoting motion by a respective arcuate receptacle 48 on the dog retainer 34. Each dog 32 also includes an elongated overhang portion 72, and a projection 75 including a stop shoulder 74 and an outer edge 78. The dog 32 is not symmetrical about the axis of the pivot portion 70, and the overhang portion 72 acts somewhat as a pendulum, swinging back and forth and causing the dog 32 to pivot relative to the dog retainer 34 about the axis of the pivot portion 70.

As best shown in FIGS. 8-11, the pivot portion 70 is received for limited rotation within a respective one of the arcuate receptacles 48 of the dog retainer 34.

As the dog retainer 34 rotates about its axis (the retainer axis), each dog 32 travels with the dog retainer 34 and pivots relative to the dog retainer 34, with the pivot portion 70 pivoting about its pivot axis within the respective arcuate receptacle 48. As each dog 32 pivots relative to the dog retainer 34, the overhang portion 72 either swings away from the axis of rotation of the dog retainer (flares radially outwardly) or falls toward the axis of rotation of the dog retainer 34 (retracts radially inwardly).

FIGS. 8 and 9 show what happens if the user drops the bottom rail 16, allowing it to fall. Referring to FIG. 8, as the dog retainer 34 rotates clockwise, if the rotational speed is greater than a desired design speed, as it would be if the covering were in “free fall”, the centrifugal action acting on the overhang portion 72 of the dog 32 prevents the overhang portion 72 from falling by gravity toward the hub 76 as the respective dog 32 approaches the top or twelve-o-clock position and instead keeps the outer edge 78 of the projection 75 in contact with the inside surface of the cavity 50 of the lock housing 36. Additional rotation of the dog retainer 34, as shown in FIG. 9, results in the stop shoulder 74 of a respective one of the dogs 32 impacting against the stop surface 68 of the lock housing 36, which also causes the rear face 77 of the locking dog 32 to engage the front edge 79 (See FIG. 8) of its respective arcuate receptacle 48, which thereby locks the dog retainer 34 against further rotation in the clockwise direction and brings the dog retainer 34 to a complete stop relative to the housing 36 of the locking dog mechanism 10. At this point, the weight of the blind prevents the locking dog mechanism 10 from reversing direction and keeps the locking dog 32 engaged with the stop surface 68 and with the front edge 79 of the receptacle 48.

It should be pointed out that the housing 36 of the locking dog mechanism 10 is fixed on the head rail 12 so it cannot rotate relative to the head rail 12, so the dog retainer 34 comes to a complete stop not only relative to the locking dog mechanism 10 but also relative to the head rail 12 of the blind 14. This causes the lift rod 26, which rotates with the dog retainer 34, also to come to a complete stop, which also stops rotation of the spools 28 of the lift and tilt stations 22. Since the lift spools 28 cannot rotate to allow the lift cords to unwind from their respective lift spools 28, the bottom rail 16 of the blind 14, which is secured to the lift cords, cannot drop any further.

To release the locking dog mechanism 10, the user raises the bottom rail 16 of the blind 14 slightly. The spring motor picks up the slack in the lift cords, rotating the dog retainer 34 and the lift rod 26 in the counter-clockwise direction just far enough for the stop shoulder 74 of the locked dog 32 to disengage from the stop surface 68 on the lock housing 36. The overhang portion 72 of the locked dog 32, under the influence of gravity, falls back toward the hub 76 of the dog retainer 34 such that the stop shoulder 74 can clear the stop surface 68 on the housing, as shown in FIG. 10. Then the user can pull the bottom rail 16 downwardly, at a slower, controlled speed, with the dog retainer 34 rotating in the clockwise direction and with the dogs 32 retracted as they pass by the stop surface 68 in the housing, as shown in FIG. 11.

As can be seen clearly in FIGS. 8-11, the stop surface 68 on the housing is shaped so that it only presents an abrupt shoulder that acts to stop the dogs 32 when the dog retainer 34 is rotating in the clockwise direction, which corresponds to lowering the bottom rail 16. When raising the bottom rail 16, the dog retainer 34 rotates counterclockwise, and the dogs 32 pass along the inner surface of the cavity 50 without encountering any abrupt stop surface that would cause them to stop the rotation of the dog retainer 34. As the operator raises or picks up on the bottom rail 16, the motor spring 40 unwinds from the output spool 38 and winds back onto the storage spool 42, using its force to assist with raising the blind and causing the dog retainer 34 to rotate in a counter-clockwise direction, which also causes the lift rod 26 and the spools 28 of the lift and tilt stations 22 to rotate so as to wind the lift cords onto the spools 28.

In this instance, the spring 40 is underpowered, so that the force provided by the spring 40 alone is not sufficient to raise the blind 14 and requires an additional catalytic force provided by the user in order to provide sufficient force to raise the blind 14. By the same token, the spring 40 is not strong enough to prevent the blind 14 from dropping when the bottom rail 16 is released by the user.

Thus, when the user releases the bottom rail 16, the force of gravity acting on the blind 14 causes the bottom rail 16 to fall downwardly, which is when the locking dog mechanism 10 comes into play and operates to stop the blind and prevent it from falling downwardly, as explained above. In this manner, the locking dog mechanism 10 causes the blind to stop in a position that is at or just slightly below the position at which the blind was released by the user.

To summarize, centrifugal force acts in a direction tending to pivot the overhang portion 72 of the dog 32 in a first (outward) direction. Gravity acts in a direction tending to pivot the overhang portion 72 in a second (inward) direction opposite the first direction as the dog 32 approaches the twelve-o-clock position. If the blind is lowered slowly, which is when it is being lowered by the operator, the dog retainer 34 rotates slowly, and the centrifugal force is not very great. Under this condition, the gravitational force overcomes the smaller centrifugal force, so the dog 32 is retracted as it approaches the stop surface 68, and it does not contact and is not stopped by the stop surface 68.

On the other hand, if the operator simply releases the bottom rail 16, allowing the bottom rail 16 to free-fall, the dog retainer 34 rotates more rapidly, causing a greater centrifugal force, which overcomes the gravitational force on the dog 32 as the dog 32 approaches the stop surface 68, and the dog 32 pivots outwardly such that the shoulder 74 on the dog 32 impacts against (catches on) the abrupt stop surface 68 of the lock housing 36, locking the blind 14 against further lowering.

As indicated earlier, the tilt rod 24 goes through the storage spool 42 of the spring motor without engaging the storage spool 42. This allows the locking dog mechanism 10 to be installed within the confines of the head rail 12, and substantially anywhere along the length of the head rail 12, even in the presence of both a lift rod 26 and a tilt rod 24.

The stop surface 68 is located at an elevation above the axis of rotation of the dog retainer 34. The orientation of the abrupt stop surface or shoulder 68 on the lock housing 36 relative to the straight up twelve o-clock position affects the sensitivity of the locking dog mechanism 10. For instance, as the location of the abrupt stop surface 68 is moved up, closer to the 12:00 o'clock position, or even to the 11:00 or 10:00 o'clock positions, the locking dog mechanism 10 will lock up at lower rotational speeds because, at a given speed, the dogs 32 will have less time to be acted upon by the force of gravity before the stop shoulder 74 impacts against the stop surface 68.

Alternate Embodiment with Shock Absorber Mechanism

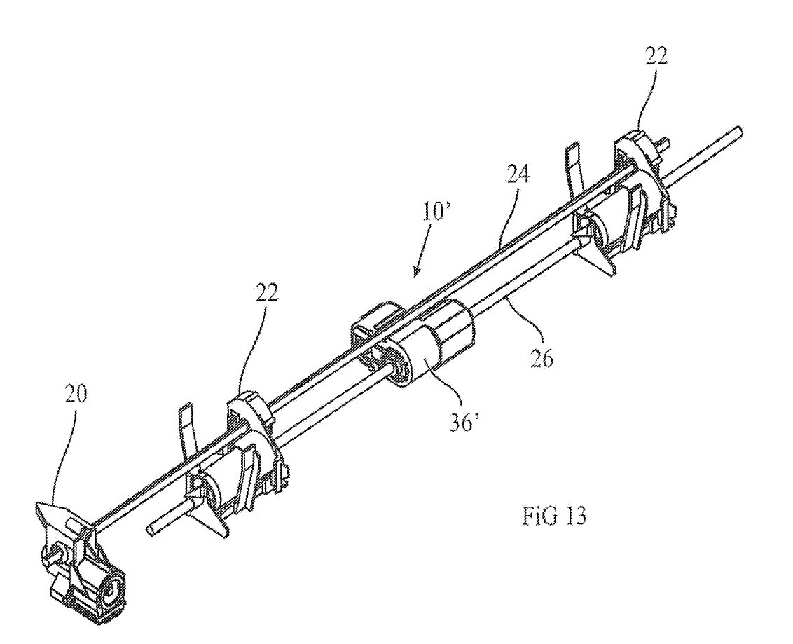

FIGS. 13-19 show a second embodiment of a locking dog mechanism 10′ which is very similar in its operation to the locking dog mechanism 10 described above with the most notable exception being the addition of a shock absorber mechanism, as described in more detail below.

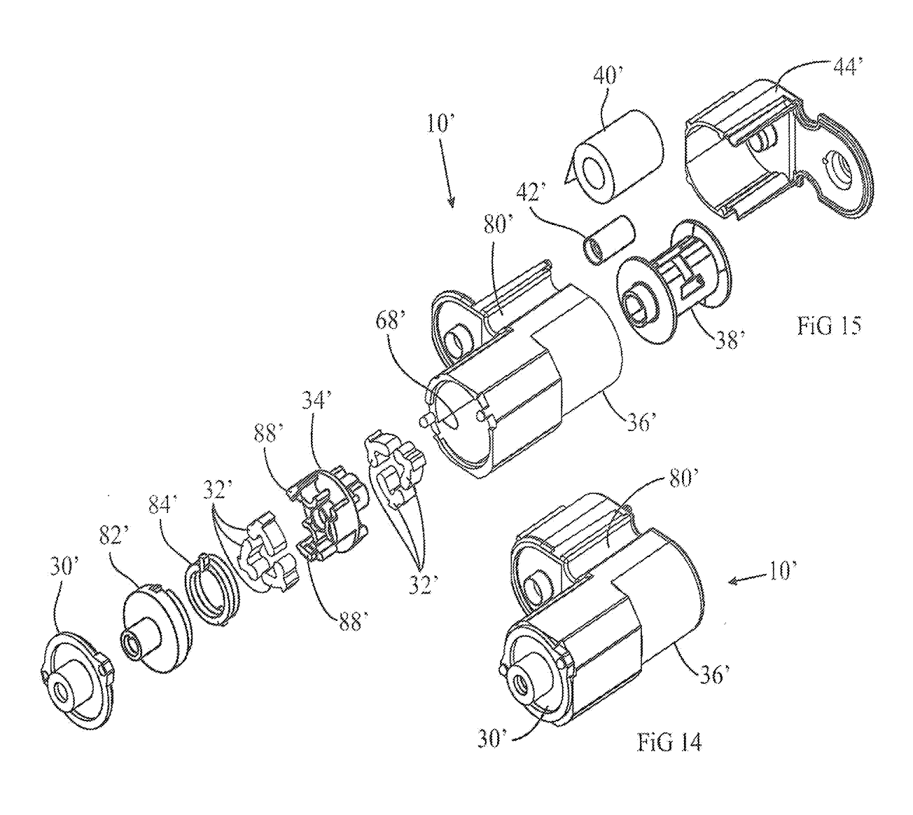

As was the case for the first locking dog mechanism 10, this locking dog mechanism 10′ is designed so that it only locks a falling rail, so the rail that supports the covering can be raised at any speed without locking up the locking dog mechanism 10′. Note that in this embodiment the tilt rod 24, which is shown in FIG. 13, passes just outside the locking dog mechanism 10′ and abuts the lock housing 36′ along an external, elongated, semi-cylindrical channel 80′ (shown in FIGS. 14 and 15) formed in the outer surface of the lock housing 36′, but is not functionally connected to the locking dog mechanism 10′. The housing 36′ of the locking dog mechanism 10′ is mounted in the head rail 12 such that the housing 36′ does not rotate relative to the head rail 12.

Referring now to FIGS. 14 and 15, the locking dog mechanism 10′ includes a housing cover 30′, dogs 32′, a dog retainer 34′, a lock housing 36′, an output spool 38′, a spring 40′, a storage spool 42′, and a spring motor cover 44′, all of which are substantially identical to their corresponding elements in the locking dog mechanism 10 described earlier. In addition, there is a spring interface member 82′ and a shock-absorbing, collapsible spring 84′, described in more detail below.

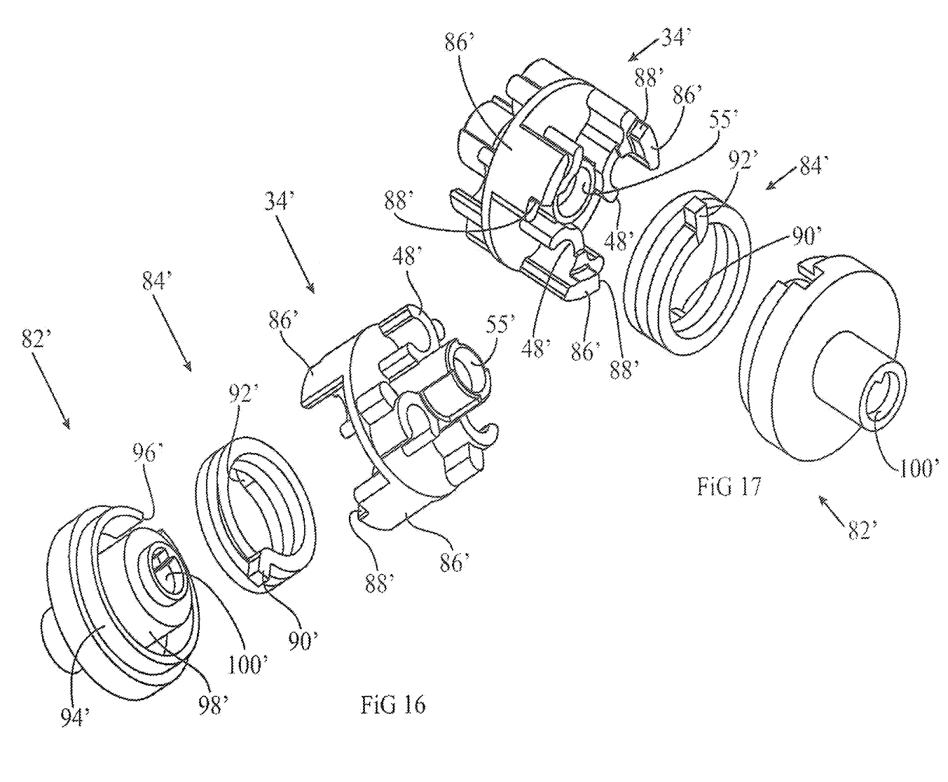

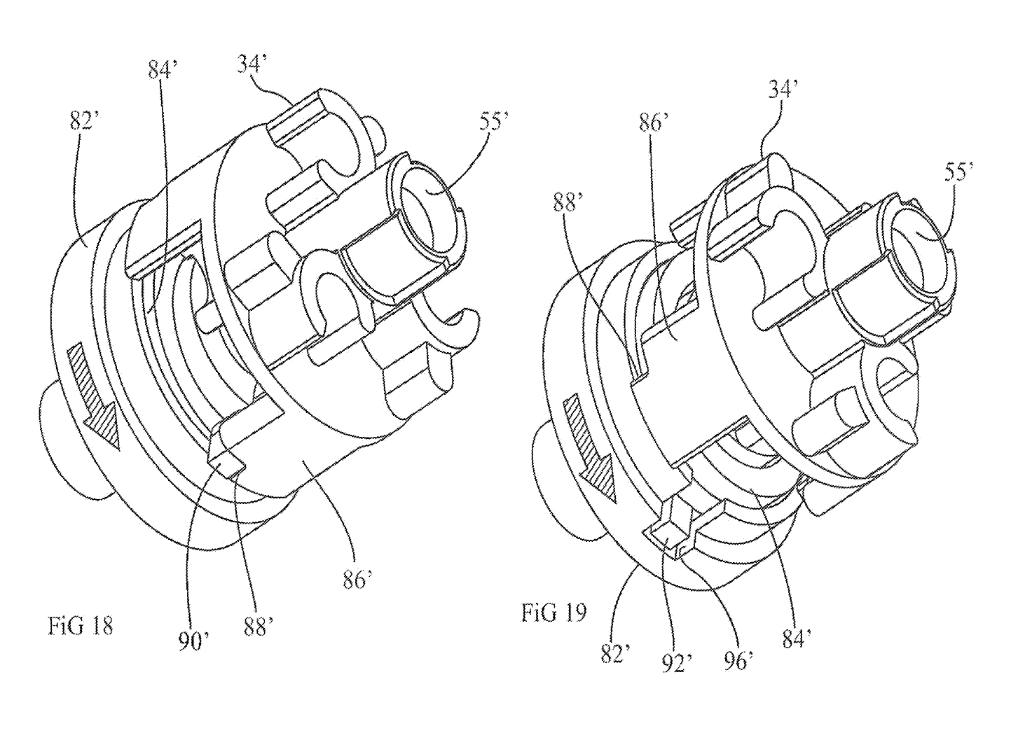

Referring now to FIGS. 16 and 17, the dog retainer 34′ is substantially identical to the dog retainer 34 of FIG. 4, except that its hollow bore 55′ now defines an internal, circular cross-sectional profile (instead of the non-circular cross-sectional profile of the dog retainer 34 shown in FIG. 5). Therefore, in this embodiment, the lift rod 26 passes through the bore 55′ of the dog retainer 34′ without engaging the dog retainer 34′. The dog retainer 34′ also includes a plurality of axially-extending, partial circumferential skirts 86′, which extend axially beyond the arcuate receptacles 48′, and each of the skirts 86′ defines a shoulder 88′ which engages an end 90′ of the shock-absorbing spring 84′, as described below.

The shock-absorbing spring 84′ is a collapsible, coiled spring having first and seconds ends 90′, 92′ which extend radially outwardly from the axis of the coiled spring 84′, which is coaxial with the dog retainer 34 and the lift rod 26.

The spring interface member 82′ includes an axially-extending, partial cylindrical skirt 94′ which defines a discontinuity or opening 96′ which receives the second end 92′ of the collapsible spring 84′, as explained below. The spring interface member 82′ also includes a short axle 98′ which rotationally supports the shock absorbing spring 84′. There is sufficient clearance between the inner circumference of the spring 84′ and the axle 98′ to allow this inner circumference of the spring 84′ to collapse to some extent (allow the coil of the spring 84′ to adopt a smaller inside diameter) before the spring 84′ snugs up around the axle 98′. The axle 98′ also defines a hollow shaft 100′ (See FIG. 17) with an internal, non-circular cross-sectional profile which closely matches the external, non-cylindrical cross-sectional profile of the lift rod 26 such that the spring interface member 82′ is “keyed” for rotation with the lift rod 26.

The spring interface member 82′ and the shock-absorbing spring 84′ provide the “shock absorber” assembly portion of the locking dog mechanism 10′.

Assembly of the “Shock Absorber”:

Referring to FIGS. 16 and 17, the shock-absorbing spring 84′ is mounted over the axle 98′ of the spring interface member 82′ with the opening 96′ of the spring interface member 82′ receiving the second end 92′ of the spring 84′, as shown in FIG. 19. This assembly is then mounted onto to the dog retainer 34′ with the first end 90′ of the spring 84′ abutting the shoulder 88′ of one of the skirts 86′ of the dog retainer 34′, as shown in FIG. 18. Of course, the dogs 32′ (See FIG. 15) are mounted onto the dog retainer 34′ before the “shock absorber” assembly is mounted onto the dog retainer 34′. The remaining components of the locking dog mechanism 10′ are assembled in essentially the same manner as the corresponding components of the locking dog mechanism 10 described earlier.

Operation of the “Shock Absorber”:

The operation of the locking dog mechanism 10′ is substantially the same as that of the locking dog mechanism 10 described earlier, with the exception that the shock absorbing spring 84′ is functionally engaged between the locking dog retainer 34′ and the lift drum 28—in this particular embodiment, it is specifically located between the locking dog retainer and the spring interface member 82′. In this embodiment 10′, the lift rod 26 does not directly engage the dog retainer 34′; instead, the lift rod 26 engages the dog retainer 34′ through the shock absorbing spring 84′ and the spring interface member 82′. This means that the lift rod 26 and the lift drum 28, which is driven by the lift rod 26, do not feel the jolt or jarring when one of the dogs 32′ abuts the stop surface 68′ and abruptly stops the rotation of the dog retainer 34′.

As the bottom rail 16 is lowered, the unwinding lift cords cause the lift drums 28 and the lift rod 26 to rotate clockwise (as seen from the vantage point of FIG. 13). Since the spring interface member 82′ is keyed to the lift rod 26, it also rotates in a clockwise direction with the lift rod 26. The second end 92′ of the collapsible spring 84′ is received in the opening 96′ of the spring interface member 82′, so it also rotates with the lift rod 26 and the spring interface member 82′. The rotation of the second end 92′ of the shock absorbing spring 84′ also causes the first end 90′ of that same spring 84′ to rotate. The first end 90′ of the shock absorbing spring 84′ abuts the shoulder 88′ of the dog retainer 34′, driving the dog retainer 34′ to rotate in the same direction as the lift rod 26 and the spring interface 82′. However, the shock absorbing spring 84′ provides a cushion between its first and second ends 90′, 92′, which means that it also provides a cushion between the spring interface member 82′ and the dog retainer 34′.

If the bottom rail 16 is lowered too quickly, as when it free-falls, one of the locking dogs 32′ engages the abrupt stopping surface or shoulder 68′ (shown in FIG. 15) in the housing 36′ of the locking dog mechanism 10′ to stop the dog retainer 34′ from further rotation. This stops the first end 90′ of the shock absorbing spring 84′. However, since the spring 84′ provides a cushion between its first and second ends 90′, 92′, the second end 92′ of the spring 84′ may continue to rotate for a time after the first end 90′ comes to a complete rotational stop along with the dog retainer 34′. The rotation of the second end 92′ relative to the stationary first end 90′ partially collapses the spring 84′, reducing the inside diameter of the spring 84′. The collapsing spring 84′ eventually will snug up onto the axle 98′ of the spring interface member 82′. At some point, either friction between the spring 84′ and the axle 98′ or contact between the second end 92′ of the spring 84′ and the side of the opening 96′ of the skirt 94′ on the spring interface member 82′ will stop the spring interface member 82′ from rotating. In either case, the spring 84′ eventually causes the spring interface member 82′ to stop rotating. Since the lift rod 26 is keyed to the spring interface member 82′, the lift rod 26 also comes to a rotational stop, which also stops the lowering of the rail 16.

It may be appreciated that the shock-absorbing spring 84′ torsionally absorbs the torque created when the locking dog mechanism 10′ is activated, thereby protecting other components of the blind against the sudden jarring caused by the locking dog mechanism 10′. The use of the spring shock absorbing mechanism means that the rotational halt of the dog retainer 34′ does not translate into an immediate and abrupt stop of the lift rod 26. Instead, the lift rod 26 (and therefore the bottom rail 16 of the blind) comes to a full stop over a distance equal to (or less than) the rotational arc distance traveled by the second end 92′ of the spring 84′ before the spring 84′ stops the rotation of the spring interface member 82′.

The embodiments described above are just two examples of arrangements made in accordance with the present invention. It will be obvious to those skilled in the art that various modifications may be made to the embodiments described above without departing from the scope of the present invention as claimed.

What is claimed is:

1. An arrangement for covering an architectural opening, comprising:
a covering material;
a movable rail which supports the covering material;
at least one lift drum mounted for rotation about a first axis, wherein rotation of said lift drum in a first direction lowers the movable rail, and rotation of said lift drum in a second, opposite direction raises the movable rail; and
a locking dog mechanism including a locking dog retainer mounted for rotation with said lift drum about a retainer axis; at least one dog mounted on said locking dog retainer for rotation with said locking dog retainer; and a locking dog housing defining a stop surface;
wherein said dog is mounted such that it flares outwardly away from said retainer axis and engages the stop surface to stop the rotation of the lift drum when the lift drum is rotating in the first direction at a high speed but allows the rotation of the lift drum in the first direction at a slower speed and allows rotation of the lift drum in the second direction regardless of speed.

2. An arrangement for covering an architectural opening as recited in claim 1, wherein said dog pivots relative to said locking dog retainer about a second axis that is parallel to said retainer axis.

3. An arrangement for covering an architectural opening as recited in claim 2, wherein the stop surface is located at an elevation above the retainer axis, and the dog engages the stop surface to stop the rotation of the lift drum when the centrifugal force on the dog caused by rotation of the locking dog retainer overcomes the gravitational force on the dog.

4. An arrangement for covering an architectural opening as recited in claim 3, and further comprising a spring motor which drives said lift drum in the second direction.

5. An arrangement for covering an architectural opening as recited in claim 4, and further comprising a shock absorbing spring functionally engaged between the locking dog retainer and the lift drum.

6. An arrangement for covering an architectural opening as recited in claim 1, and further comprising a shock absorbing spring functionally engaged between the locking dog retainer and the lift drum.
